(19) United States
(12) Patent Application Publication
(10) Pub. No.: US 2026/0256157 A1
(43) Pub. Date: Sep. 3, 2026

(54) ACTIVATED FERRATE SOLUTIONS AND METHODS THEREOF

(71) Applicants: THE TEXAS A&M UNIVERSITY SYSTEM, College Station, TX (US); DEPARTMENT OF VETERANS AFFAIRS, Washington, DC (US)

(72) Inventors: Virender K. SHARMA, College Station, TX (US); Jinadatha CHETAN, Washington, DC (US)

(21) Appl. No.: 18/291,021

(22) PCT Filed: Jul. 21, 2022
(86) PCT No.: PCT/US2022/073993

§ 371 Date: Jan. 22, 2024

Related U.S. Application Data
(60) Provisional application No. 63/224,550, filed on Jul. 22, 2021.

(51) Int. Cl. A23B 7/157

(52) U.S. Cl. CPC A23B 7/157

(57) ABSTRACT

The present disclosure provides methods of treating produce, said method comprising the step of contacting the produce with a ferrate solution. According to the present disclosure, the described methods can prolong shelf life of the produce, disinfect the produce, and/or decontaminate the produce. Advantageously, methods of the present disclosure can be used in a multitude of settings, including agriculture fields, processing facilities, and stores such as grocery stores and supermarkets to improve food supply of produce and prevent illness outbreaks.

### CROSS-REFERENCE TO RELATED APPLICATIONS

This application claims the benefit under 35 USC § 119(e) of U.S. Provisional Application Ser. No. 63/224,550, filed on Jul. 22, 2021, the entire disclosure of which is incorporated herein by reference.

### BACKGROUND AND SUMMARY OF THE INVENTION

Food-borne illness are problematic for every person that purchases food. In recent years, media reports of outbreaks associated with fruits and vegetables contaminated with bacteria, fungi, and protozoa have become more commonplace. Furthermore, produce contaminated with Escherichia coli(E. coli) has been associated with ailments such diarrheal illnesses and even death. It is imperative to take steps to protect food supplies in order to feed the growing population.

Typically, contamination of produce with microorganisms occurs either in agricultural fields or due to unclean water used to wash produce before and during packaging. Further, when produce is consumed raw (e.g., spinach, lettuce, and tomatoes) it is generally not washed again in the home prior to consumption. Similar illnesses have been reported with raspberries and strawberries contaminated with Giardia and Cyclospora that are imported. Thus, proper disinfection or decontamination of produce in the field or during packaging is critical to prevention of further outbreaks of illness.

Moreover, another potential source of produce contamination is at the place of purchase. For example, produce in supermarkets is typically placed on shelves and then sprayed with water to maintain its freshness. This results in a further chance of contamination of the produce that must be addressed. The SARS-COV-2 pandemic has only highlighted this issue, as frequent washing of produce in stores has become more commonplace in order to prevent the spread of COVID-19.

Although several products can be used to decontaminate produce, the vast majority of these products are chemical-based and utilizing these chemicals may have harmful effects on the produce. As a result, the shelf life of the produce may be reduced, thus leading to an increase in food waste as well as lost income and productivity. Further, use of these chemicals may result in a loss of an organic product claim for farmers which may be undesirable.

There is a need for a product that disinfect and lead to no reduction of shelf life better yet a product that can disinfect and improve the shelf life as well as act as pesticide with greener and sustainable practices.

Therefore, there exists a need for new compositions and methods that provide disinfecting and/or decontamination of produce to provide for increased shelf life and freshness of the produce. Such compositions and methods could be capable as of removing pesticides and chemicals as well as decreasing the presence of microorganisms on or in the produce. In turn, these new mechanisms can provide greener and more sustainable practices for the food supply.

Accordingly, the present disclosure provides methods utilizing ferrate solutions for disinfecting and/or decontamination of produce. Application of such methods can prolong the shelf life of the produce and thus result in increased sustainability of the produce for food security.

The compositions and methods of the present disclosure provide benefits compared to the current state of the art. First, there is currently no mechanism to activate the disinfectant properties of ferrate for commercial use because of issues with its inactivity, high basicity, and stability. The methods of the present disclosure provides an activated ferrate solution that possesses the capability for disinfecting and/or decontamination of produce.

Second, the activated ferrate solution utilized in the methods of the present disclosure needs no equipment to produce and can thus be made inexpensively and on short notice. Third, the methods of the present disclosure are capable of removing harmful pesticides and chemicals from produce via neutralization by activated ferrate solution that is unrelated to mechanical washing of the produce. Fourth, the methods of the present disclosure can utilize application of an activated ferrate solution in combination with other disinfectants, including bleach, to provide enhanced efficacy. Fifth, the methods of the present disclosure can be used in a multitude of settings, including agriculture fields, processing facilities, and stores such as grocery stores and supermarkets.

Other objects, features and advantages of the present disclosure will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 shows a large amount of bacterial growth observed on untreated spinach that was observed for 24 hours after being contaminated with E. coli.

FIG. 2 shows some bacterial growth observed on spinach that was treated with plain tap water and observed for 24 hours after being contaminated with E. coli.

FIG. 3 shows significant elimination of bacterial growth observed on spinach that was treated with the activated ferrate solution and observed for 24 hours after being contaminated with E. coli.

FIG. 4 shows a comparison of the spinach treated with activated ferrate solution (left side) and the spinach treated with plain tap water (right side).

### DETAILED DESCRIPTION

Various embodiments of the invention are described herein as follows. In an illustrative aspect, a method of treating produce is provided. The method comprises the step of contacting the produce with a ferrate solution. In another illustrative aspect, a method of extending the shelf life of produce is provided. The method comprises the step of contacting the produce with a ferrate solution, wherein the contacting extends the shelf life of the produce. In yet another illustrative aspect, a method of disinfecting produce is provided. The method comprises the step of contacting the produce with a ferrate solution, wherein the contacting disinfects the produce. In another illustrative aspect, a method of decontaminating produce is provided. The method comprises the step of contacting the produce with a ferrate solution, wherein the contacting decontaminates the produce.

Ferrate solutions that can be used according to the methods described herein include the various aqueous activated ferrate solutions described in U.S. Patent Application Publication No. 2021/0030008, which is incorporated herein in its entirety. Furthermore, means for forming the ferrate solutions of the present disclosure are described in U.S. Patent Application Publication No. 2021/0030008, which is incorporated herein in its entirety.

For instance, an activated ferrate solution can comprise (a) water; (b) one or more cations selected from cations of alkali metals, cations of alkali earth metals, ammonium ions, and combinations thereof; (c) one or more activating agents; and (d) ferrate.

As used herein, “ferrate”, also referred to interchangeably as Fe^{VI}O₄²⁻, “Fe^{VI}O₄²⁻”, and “ferrate(VI),” refers to tetraoxy iron in +6 oxidation state with the chemical formula [FeO₄]²⁻ or a material comprising an oxycompound of iron in an oxidation state of six.

In certain embodiments, the activated ferrate solutions have a concentration of ferrate from about 0.001 wt % to about 1.0 wt %. As used herein, the term “about” refers to +/−5% of the recited value. In certain embodiments, the activated ferrate solutions have a concentration of Fe^{VI}O₄²⁻ or ferrate of about 5.0 wt %.

In certain embodiments, the water is undistilled, non-deionized, tap, distilled, deionized, or DDI water. Potable or non-potable water can be used to prepare the activated ferrate solutions disclosed herein. Regular tap water, e.g., water that has not been distilled or deionized, can be used in preparation of the activated ferrate solutions provided herein, reducing the costs of preparation of the activated ferrate solutions. Alternatively, distilled or deionized water with the addition of one or more actions and one or more anions can be used. In some instances, the one or more activating agents comprise an anion. The anions suitable for the inclusion in the activated ferrate solutions provided herein comprise carbonate, sulfate ions, and combinations thereof. The cations comprise cations of alkali metals, cations of alkali earth metals, ammonium ions, and combinations thereof.

In some embodiments, the concentration of the one or more cations is from about 0.0001 M to about 0.025 M. In certain embodiments, the concentration of the one or more anions is between from 0.0001 M to about 1.0 M.

In some embodiments, the one or more activating agents is an organic acids such as a carboxylic acid. Suitable carboxylic acids are selected from acetic acid, formic acid, citric acid, ascorbic acid, peracetic acid and combinations thereof.

In some embodiments, the activating agent is a carbonate, bicarbonate, thiosulfate, or sulfite, hydrogen peroxide In some embodiments, the activating agent for ferrate is a carbonate. Suitable carbonates are selected from but not limited to sodium bicarbonate, potassium bicarbonate, and calcium bicarbonate. In other embodiments, the activating agent is thiosulfate.

In some embodiments, the concentration of the one or more activating agents, e.g., carbonates, is from about 0.0001 Millimolar to about 2.0 Millimolar. In certain embodiments, the concentration of the one or more anions is from about 0.0001 Millimolar to about 2.0 Millimolar.

Surprisingly, the activated ferrate solutions provided herein have a pH from about 8.0 to about 10.5 and are stable within this pH range, making them suitable for common disinfecting purposes. In some embodiments, the solutions can further comprise a disinfectant selected from sodium hypochlorite, chloramine, quaternary alkylamines, and combinations thereof. For example, the disinfectant can be sodium hypochlorite present in the activated ferrate solution at a concentration of between about 0.001 wt % and about 1.0 wt %. Additionally, the activated ferrate solutions provided herein can further comprise one or more surfactants.

Without being bound by any theory, it is believed that the ferrate solutions of the present disclosure (e.g., activated ferrate solutions) possess a lower basicity (or close to neutral pH) compared to other ferrate solutions. Further, the ferrate solutions of the present disclosure demonstrate less corrosivity to surface, if any at all. The ferrate solutions of the present disclosure possess a stabilized ferrate molecule in solution as well as activity to perform multimodal functions of disinfection, oxidation, and coagulation. These are advantages of the disclosed ferrate solutions and provide unexpected properties of the solutions as described herein.

In any of the disclosed methods, the method can prolong shelf life of the produce. In any of the disclosed methods, the method can disinfect the produce. In any of the disclosed methods, the method can decontaminate the produce.

In an embodiment, the produce is a food. In an embodiment, the produce is a meat. In an embodiment, the meat is beef. In an embodiment, the meat is pork. In an embodiment, the meat is lamb. In an embodiment, the meat is fish. In an embodiment, the meat is shellfish. In an embodiment, the meat is from a bison. In an embodiment, the meat is from a chicken. In an embodiment, the meat is from a deer. In an embodiment, the meat is from a goat. In an embodiment, the meat is from a turkey. In an embodiment, the meat is from a mollusk. In an embodiment, the meat is a dry-cured meat product. In an embodiment, the produce is seafood. In an embodiment, the produce is poultry. In an embodiment, the produce is an egg.

In an embodiment, the produce is a fruit. In an embodiment, the fruit is a berry. In an embodiment, the berry is a strawberry. In an embodiment, the berry is a blueberry. In an embodiment, the berry is a raspberry. In an embodiment, the berry is a blackberry. In an embodiment, the berry is a cranberry. In an embodiment, the berry is a current.

In an embodiment, the fruit is an apple. In an embodiment, the fruit is an avocado. In an embodiment, the fruit is a banana. In an embodiment, the fruit is a carambola. In an embodiment, the fruit is a cherry. In an embodiment, the fruit is an orange. In an embodiment, the fruit is a lemon. In an embodiment, the fruit is a lime. In an embodiment, the fruit is a mandarin. In an embodiment, the fruit is a grapefruit. In an embodiment, the fruit is a coconut. In an embodiment, the fruit is a fig. In an embodiment, the fruit is a grape. In an embodiment, the fruit is a guava. In an embodiment, the fruit is a kiwifruit. In an embodiment, the fruit is a mango. In an embodiment, the fruit is a nectarine. In an embodiment, the fruit is a cantaloupe. In an embodiment, the fruit is a muskmelon. In an embodiment, the fruit is a watermelon. In an embodiment, the fruit is an olive. In an embodiment, the fruit is a papaya. In an embodiment, the fruit is a passionfruit. In an embodiment, the fruit is a peach. In an embodiment, the fruit is a pear. In an embodiment, the fruit is a persimmon. In an embodiment, the fruit is a pineapple. In an embodiment, the fruit is a plum. In an embodiment, the fruit is a pomegranate.

In an embodiment, the produce is a vegetable. In an embodiment, the vegetable is spinach. In an embodiment, the vegetable is lettuce. In an embodiment, the vegetable is a sprout. In an embodiment, the vegetable is asparagus. In an embodiment, the vegetable is a beet. In an embodiment, the vegetable is a bean. In an embodiment, the vegetable is broccoli. In an embodiment, the vegetable is cabbage. In an embodiment, the vegetable is a carrot. In an embodiment, the vegetable is a cassava. In an embodiment, the vegetable is a cauliflower. In an embodiment, the vegetable is celery. In an embodiment, the vegetable is a cucumber. In an embodiment, the vegetable is an eggplant. In an embodiment, the vegetable is garlic. In an embodiment, the vegetable is a gherkin. In an embodiment, the vegetable is kale. In an embodiment, the vegetable is a leek. In an embodiment, the vegetable is lentils. In an embodiment, the vegetable is a mushroom. In an embodiment, the vegetable is an onion. In an embodiment, the vegetable is a pea. In an embodiment, the vegetable is a pepper. In an embodiment, the vegetable is a potato. In an embodiment, the vegetable is a pumpkin. In an embodiment, the vegetable is a sweet potato. In an embodiment, the vegetable is a snap bean. In an embodiment, the vegetable is a squash. In an embodiment, the vegetable is a turnip.

In an embodiment, the produce is raw produce. As used herein, the term “raw produce” refers to a produce that is generally capable of being eaten without cooking the produce.

In an embodiment, the method of treating is performed in a field. In an embodiment, the method of treating is performed in a processing facility. In an embodiment, the processing facility is a plant processing facility or a plant part processing facility. In an embodiment, the processing facility is a meat processing facility. In an embodiment, the processing facility is a seafood processing facility. In an embodiment, the processing facility is a poultry processing facility. In an embodiment, the processing facility is an egg processing facility. In an embodiment, the method of treating is performed in a fishery.

In an embodiment, the method of treating is performed in a store. In an embodiment, the store is a grocery store. In an embodiment, the store is a supermarket.

In an embodiment, the ferrate solution provides removal of one or more pesticides from the produce. In an embodiment, the ferrate solution provides removal of one or more chemicals from the produce.

In an embodiment, the ferrate solution provides decrease of one or more microorganisms from the surface of the produce. In an embodiment, the microorganism is a bacteria. In an embodiment, the bacteria is a Gram positive bacteria. In an embodiment, the bacteria is a Gram negative bacteria. In an embodiment, the bacteria is a Listeria spp. In an embodiment, the bacteria is Listeria monocytogenes.In an embodiment, the bacteria is a Escherichia spp. In an embodiment, the bacteria is Escherichia coli.In an embodiment, the bacteria is a Salmonella spp. In an embodiment, the microorganism is a fungus. In an embodiment, the microorganism is a virus. In an embodiment, the microorganism is a spore.

In an embodiment, the ferrate solution provides decrease of one or more microorganisms present internally in the produce. In an embodiment, the microorganism is a bacteria. In an embodiment, the bacteria is a Gram positive bacteria. In an embodiment, the bacteria is a Gram negative bacteria. In an embodiment, the bacteria is a Listeria spp. In an embodiment, the bacteria is Listeria monocytogenes.In an embodiment, the bacteria is an Escherichia spp. In an embodiment, the bacteria is Escherichia coli.In an embodiment, the bacteria is a Salmonella spp. In an embodiment, the microorganism is a fungus. In an embodiment, the microorganism is a virus. In an embodiment, the microorganism is a spore.

In an embodiment, the method of treating is a liquid treatment. In an embodiment, the liquid treatment is selected from the group consisting of spraying, drenching, dipping, irrigating, and any combination thereof.

In an embodiment, the method of treating further comprises contacting the produce with a disinfectant. In an embodiment, the disinfectant comprises bleach. In an embodiment, the disinfectant comprises a quaternary ammonium compound.

In an embodiment, contacting the produce with a ferrate solution is for a time period of between about 1 minute to about 120 minutes. In an embodiment, contacting the produce with a ferrate solution is for a time period of between about 1 minute to about 120 minutes. In an embodiment, contacting the produce with a ferrate solution is for a time period of between about 1 minute to about 30 minutes. In an embodiment, contacting the produce with a ferrate solution is for a time period of between about 30 minutes to about 60 minutes. In an embodiment, contacting the produce with a ferrate solution is for a time period of between about 60 minutes to about 90 minutes. In an embodiment, contacting the produce with a ferrate solution is for a time period of between about 90 minutes to about 120 minutes. In an embodiment, contacting the produce with a ferrate solution is for a time period of between about 1 minutes to about 5 minutes. In an embodiment, contacting the produce with a ferrate solution is for a time period of between about 1 minutes to about 10 minutes. In an embodiment, contacting the produce with a ferrate solution is for a time period of between about 10 minutes to about 20 minutes. In an embodiment, contacting the produce with a ferrate solution is for a time period of between about 20 minutes to about 30 minutes. In an embodiment, contacting the produce with a ferrate solution is for a time period of between about 30 minutes to about 40 minutes. In an embodiment, contacting the produce with a ferrate solution is for a time period of between about 40 minutes to about 50 minutes. In an embodiment, contacting the produce with a ferrate solution is for a time period of between about 50 minutes to about 60 minutes. In an embodiment, contacting the produce with a ferrate solution is for a time period of between about 60 minutes to about 70 minutes. In an embodiment, contacting the produce with a ferrate solution is for a time period of between about 70 minutes to about 80 minutes. In an embodiment, contacting the produce with a ferrate solution is for a time period of between about 80 minutes to about 90 minutes. In an embodiment, contacting the produce with a ferrate solution is for a time period of between about 90 minutes to about 100 minutes. In an embodiment, contacting the produce with a ferrate solution is for a time period of between about 100 minutes to about 110 minutes. In an embodiment, contacting the produce with a ferrate solution is for a time period of between about 110 minutes to about 120 minutes.

The following numbered embodiments are contemplated and are non-limiting:
1. A method of treating produce, said method comprising the step of contacting the produce with a ferrate solution.
2. A method of extending the shelf life of produce, said method comprising the step of contacting the produce with a ferrate solution, wherein the contacting extends the shelf life of the produce.
3. A method of disinfecting produce, said method comprising the step of contacting the produce with a ferrate solution, wherein the contacting disinfects the produce.
4. A method of decontaminating produce, said method comprising the step of contacting the produce with a ferrate solution, wherein the contacting decontaminates the produce.
5. The method of any of clauses 1 to 4, any other suitable clause, or any combination of suitable clauses, wherein the method prolongs shelf life of the produce.
6. The method of any of clauses 1 to 4, any other suitable clause, or any combination of suitable clauses, wherein the method disinfects the produce.
7. The method of any of clauses 1 to 4, any other suitable clause, or any combination of suitable clauses, wherein the method decontaminates the produce.
8. The method of any of clauses 1 to 4, any other suitable clause, or any combination of suitable clauses, wherein the produce is a food.
9. The method of any of clauses 1 to 4, any other suitable clause, or any combination of suitable clauses, wherein the produce is a meat.
10. The method of clause 9, any other suitable clause, or any combination of suitable clauses, wherein the meat is beef.
11. The method of clause 9, any other suitable clause, or any combination of suitable clauses, wherein the meat is pork.
12. The method of clause 9, any other suitable clause, or any combination of suitable clauses, wherein the meat is lamb.
13. The method of clause 9, any other suitable clause, or any combination of suitable clauses, wherein the meat is fish.
14. The method of clause 9, any other suitable clause, or any combination of suitable clauses, wherein the meat is shellfish.
15. £ The method of clause 9, any other suitable clause, or any combination of suitable clauses, wherein the meat is from a bison.
16. The method of clause 9, any other suitable clause, or any combination of suitable clauses, wherein the meat is from a chicken.
17. The method of clause 9, any other suitable clause, or any combination of suitable clauses, wherein the meat is from a deer.
18. The method of clause 9, any other suitable clause, or any combination of suitable clauses, wherein the meat is from a goat.
19. The method of clause 9, any other suitable clause, or any combination of suitable clauses, wherein the meat is from a turkey.
20. The method of clause 9, any other suitable clause, or any combination of suitable clauses, wherein the meat is from a mollusk.
21. The method of clause 9, any other suitable clause, or any combination of suitable clauses, wherein the meat is a dry-cured meat product.
22. The method of any of clauses 1 to 4, any other suitable clause, or any combination of suitable clauses, wherein the produce is seafood.
23. The method of any of clauses 1 to 4, any other suitable clause, or any combination of suitable clauses, wherein the produce is poultry.
24. The method of any of clauses 1 to 4, any other suitable clause, or any combination of suitable clauses, wherein the produce is an egg.
25. The method of any of clauses 1 to 4, any other suitable clause, or any combination of suitable clauses, wherein the produce is a fruit.
26. The method of clause 25, any other suitable clause, or any combination of suitable clauses, wherein the fruit is a berry.
27. The method of clause 26, any other suitable clause, or any combination of suitable clauses, wherein the berry is a strawberry.
28. The method of clause 26, any other suitable clause, or any combination of suitable clauses, wherein the berry is a blueberry.
29. The method of clause 26, any other suitable clause, or any combination of suitable clauses, wherein the berry is a raspberry.
30. The method of clause 26, any other suitable clause, or any combination of suitable clauses, wherein the berry is a blackberry.
31. The method of clause 26, any other suitable clause, or any combination of suitable clauses, wherein the berry is a cranberry.
32. The method of clause 26, any other suitable clause, or any combination of suitable clauses, wherein the berry is a current.
33. The method of clause 25, any other suitable clause, or any combination of suitable clauses, wherein the fruit is an apple.
34. The method of clause 25, any other suitable clause, or any combination of suitable clauses, wherein the fruit is an avocado.
35. The method of clause 25, any other suitable clause, or any combination of suitable clauses, wherein the fruit is a banana.
36. The method of clause 25, any other suitable clause, or any combination of suitable clauses, wherein the fruit is a carambola.
37. The method of clause 25, any other suitable clause, or any combination of suitable clauses, wherein the fruit is a cherry.
38. The method of clause 25, any other suitable clause, or any combination of suitable clauses, wherein the fruit is an orange.
39. The method of clause 25, any other suitable clause, or any combination of suitable clauses, wherein the fruit is a lemon.
40. The method of clause 25, any other suitable clause, or any combination of suitable clauses, wherein the fruit is a lime.
41. The method of clause 25, any other suitable clause, or any combination of suitable clauses, wherein the fruit is a mandarin.
42. The method of clause 25, any other suitable clause, or any combination of suitable clauses, wherein the fruit is a grapefruit.
43. The method of clause 25, any other suitable clause, or any combination of suitable clauses, wherein the fruit is a coconut.
44. The method of clause 25, any other suitable clause, or any combination of suitable clauses, wherein the fruit is a FIG.
45. The method of clause 25, any other suitable clause, or any combination of suitable clauses, wherein the fruit is a grape.
46. The method of clause 25, any other suitable clause, or any combination of suitable clauses, wherein the fruit is a guava.
47. The method of clause 25, any other suitable clause, or any combination of suitable clauses, wherein the fruit is a kiwifruit.
48. The method of clause 25, any other suitable clause, or any combination of suitable clauses, wherein the fruit is a mango.
49. The method of clause 25, any other suitable clause, or any combination of suitable clauses, wherein the fruit is a nectarine.
50. The method of clause 25, any other suitable clause, or any combination of suitable clauses, wherein the fruit is a cantaloupe.
51. The method of clause 25, any other suitable clause, or any combination of suitable clauses, wherein the fruit is a muskmelon.
52. The method of clause 25, any other suitable clause, or any combination of suitable clauses, wherein the fruit is a watermelon.
53. The method of clause 25, any other suitable clause, or any combination of suitable clauses, wherein the fruit is an olive.
54. The method of clause 25, any other suitable clause, or any combination of suitable clauses, wherein the fruit is a papaya.
55. The method of clause 25, any other suitable clause, or any combination of suitable clauses, wherein the fruit is a passionfruit.
56. The method of clause 25, any other suitable clause, or any combination of suitable clauses, wherein the fruit is a peach.
57. The method of clause 25, any other suitable clause, or any combination of suitable clauses, wherein the fruit is a pear.
58. The method of clause 25, any other suitable clause, or any combination of suitable clauses, wherein the fruit is a persimmon.
59. The method of clause 25, any other suitable clause, or any combination of suitable clauses, wherein the fruit is a pineapple.
60. The method of clause 25, any other suitable clause, or any combination of suitable clauses, wherein the fruit is a plum.
61. The method of clause 25, any other suitable clause, or any combination of suitable clauses, wherein the fruit is a pomegranate.
62. The method of any of clauses 1 to 4, any other suitable clause, or any combination of suitable clauses, wherein the produce is a vegetable.
63. The method of clause 62, any other suitable clause, or any combination of suitable clauses, wherein the vegetable is spinach.
64. The method of clause 62, any other suitable clause, or any combination of suitable clauses, wherein the vegetable is lettuce.
65. The method of clause 62, any other suitable clause, or any combination of suitable clauses, wherein the vegetable is a sprout.
66. The method of clause 62, any other suitable clause, or any combination of suitable clauses, wherein the vegetable is asparagus.
67. The method of clause 62, any other suitable clause, or any combination of suitable clauses, wherein the vegetable is a beet.
68. The method of clause 62, any other suitable clause, or any combination of suitable clauses, wherein the vegetable is a bean.
69. The method of clause 62, any other suitable clause, or any combination of suitable clauses, wherein the vegetable is broccoli.
70. The method of clause 62, any other suitable clause, or any combination of suitable clauses, wherein the vegetable is cabbage.
71. The method of clause 62, any other suitable clause, or any combination of suitable clauses, wherein the vegetable is a carrot.
72. The method of clause 62, any other suitable clause, or any combination of suitable clauses, wherein the vegetable is a cassava.
73. The method of clause 62, any other suitable clause, or any combination of suitable clauses, wherein the vegetable is a cauliflower.
74. The method of clause 62, any other suitable clause, or any combination of suitable clauses, wherein the vegetable is celery.
75. The method of clause 62, any other suitable clause, or any combination of suitable clauses, wherein the vegetable is a cucumber.
76. The method of clause 62, any other suitable clause, or any combination of suitable clauses, wherein the vegetable is an eggplant.
77. The method of clause 62, any other suitable clause, or any combination of suitable clauses, wherein the vegetable is garlic.
78. The method of clause 62, any other suitable clause, or any combination of suitable clauses, wherein the vegetable is a gherkin.
79. The method of clause 62, any other suitable clause, or any combination of suitable clauses, wherein the vegetable is kale.
80. The method of clause 62, any other suitable clause, or any combination of suitable clauses, wherein the vegetable is a leek.
81. The method of clause 62, any other suitable clause, or any combination of suitable clauses, wherein the vegetable is lentils.
82. The method of clause 62, any other suitable clause, or any combination of suitable clauses, wherein the vegetable is a mushroom.
83. The method of clause 62, any other suitable clause, or any combination of suitable clauses, wherein the vegetable is an onion.
84. The method of clause 62, any other suitable clause, or any combination of suitable clauses, wherein the vegetable is a pea.
85. The method of clause 62, any other suitable clause, or any combination of suitable clauses, wherein the vegetable is a pepper.
86. The method of clause 62, any other suitable clause, or any combination of suitable clauses, wherein the vegetable is a potato.
87. The method of clause 62, any other suitable clause, or any combination of suitable clauses, wherein the vegetable is a pumpkin.
88. The method of clause 62, any other suitable clause, or any combination of suitable clauses, wherein the vegetable is a sweet potato.
89. The method of clause 62, any other suitable clause, or any combination of suitable clauses, wherein the vegetable is a snap bean.
90. The method of clause 62, any other suitable clause, or any combination of suitable clauses, wherein the vegetable is a squash.
91. The method of clause 62, any other suitable clause, or any combination of suitable clauses, wherein the vegetable is a turnip.
92. The method of any of clauses 1 to 4, any other suitable clause, or any combination of suitable clauses, wherein the produce is raw produce.
93. The method of any of clauses 1 to 4, any other suitable clause, or any combination of suitable clauses, wherein the method of treating is performed in a field.
94. The method of any of clauses 1 to 4, any other suitable clause, or any combination of suitable clauses, wherein the method of treating is performed in a processing facility.
95. The method of clause 94, any other suitable clause, or any combination of suitable clauses, wherein the processing facility is a plant or plant part processing facility.
96. The method of clause 94, any other suitable clause, or any combination of suitable clauses, wherein the processing facility is a meat processing facility.
97. The method of clause 94, any other suitable clause, or any combination of suitable clauses, wherein the processing facility is a seafood processing facility.
98. The method of clause 94, any other suitable clause, or any combination of suitable clauses, wherein the processing facility is a poultry processing facility.
99. The method of clause 94, any other suitable clause, or any combination of suitable clauses, wherein the processing facility is an egg processing facility.
100. The method of any of clauses 1 to 4, any other suitable clause, or any combination of suitable clauses, wherein the method of treating is performed in a fishery.
101. The method of any of clauses 1 to 4, any other suitable clause, or any combination of suitable clauses, wherein the method of treating is performed in a store.
102. The method of clause 101, any other suitable clause, or any combination of suitable clauses, wherein the store is a grocery store.
103. The method of clause 101, any other suitable clause, or any combination of suitable clauses, wherein the store is a supermarket.
104. The method of any of clauses 1 to 4, any other suitable clause, or any combination of suitable clauses, wherein the ferrate solution provides removal of one or more pesticides from the produce.
105. The method of any of clauses 1 to 4, any other suitable clause, or any combination of suitable clauses, wherein the ferrate solution provides removal of one or more chemicals from the produce.
106. The method of any of clauses 1 to 4, any other suitable clause, or any combination of suitable clauses, wherein the ferrate solution provides removal of one or more pesticides from the produce.
107. The method of any of clauses 1 to 4, any other suitable clause, or any combination of suitable clauses, wherein the ferrate solution provides decrease of one or more microorganisms from the surface of the produce.
108. The method of clause 107, any other suitable clause, or any combination of suitable clauses, wherein the microorganism is a bacteria.
109. The method of clause 108, any other suitable clause, or any combination of suitable clauses, wherein the bacteria is a Gram positive bacteria.
110. The method of clause 108, any other suitable clause, or any combination of suitable clauses, wherein the bacteria is a Gram negative bacteria.
111. The method of clause 108, any other suitable clause, or any combination of suitable clauses, wherein the bacteria is a Listeria spp.
112. The method of clause 108, any other suitable clause, or any combination of suitable clauses, wherein the bacteria is Listeria monocytogenes.
113. The method of clause 108, any other suitable clause, or any combination of suitable clauses, wherein the bacteria is a Escherichia spp.
114. The method of clause 108, any other suitable clause, or any combination of suitable clauses, wherein the bacteria is Escherichia coli.
115. The method of clause 108, any other suitable clause, or any combination of suitable clauses, wherein the bacteria is a Salmonella spp.
116. The method of clause 107, any other suitable clause, or any combination of suitable clauses, wherein the microorganism is a fungus.
117. The method of clause 107, any other suitable clause, or any combination of suitable clauses, wherein the microorganism is a virus.
118. The method of clause 107, any other suitable clause, or any combination of suitable clauses, wherein the microorganism is a spore.
119. The method of any of clauses 1 to 4, any other suitable clause, or any combination of suitable clauses, wherein the ferrate solution provides decrease of one or more microorganisms present internally in the produce.
120. The method of clause 119, any other suitable clause, or any combination of suitable clauses, wherein the microorganism is a bacteria.
121. The method of clause 120, any other suitable clause, or any combination of suitable clauses, wherein the bacteria is a Gram positive bacteria.
122. The method of clause 120, any other suitable clause, or any combination of suitable clauses, wherein the bacteria is a Gram negative bacteria.
123. The method of clause 120, any other suitable clause, or any combination of suitable clauses, wherein the bacteria is a Listeria spp.
124. The method of clause 120, any other suitable clause, or any combination of suitable clauses, wherein the bacteria is Listeria monocytogenes.
125. The method of clause 120, any other suitable clause, or any combination of suitable clauses, wherein the bacteria is a Escherichia spp.
126. The method of clause 120, any other suitable clause, or any combination of suitable clauses, wherein the bacteria is Escherichia coli.
127. The method of clause 120, any other suitable clause, or any combination of suitable clauses, wherein the bacteria is a Salmonella spp.
128. The method of clause 119, any other suitable clause, or any combination of suitable clauses, wherein the microorganism is a fungus.
129. The method of clause 119, any other suitable clause, or any combination of suitable clauses, wherein the microorganism is a virus.
130. The method of clause 119, any other suitable clause, or any combination of suitable clauses, wherein the microorganism is a spore.
131. The method of any of clauses 1 to 4, any other suitable clause, or any combination of suitable clauses, wherein the method of treating is a liquid treatment.
132. The method of clause 131, any other suitable clause, or any combination of suitable clauses, wherein the liquid treatment is selected from the group consisting of spraying, drenching, dipping, irrigating, and any combination thereof.
133. The method of any of clauses 1 to 4, any other suitable clause, or any combination of suitable clauses, wherein contacting the produce with the ferrate solution is for a time period of between about 1 minute to about 120 minutes.
134. The method of any of clauses 1 to 4, any other suitable clause, or any combination of suitable clauses, wherein contacting the produce with the ferrate solution is for a time period of between about 1 minute to about 120 minutes.
135. The method of any of clauses 1 to 4, any other suitable clause, or any combination of suitable clauses, wherein contacting the produce with the ferrate solution is for a time period of between about 1 minute to about 30 minutes.
136. The method of any of clauses 1 to 4, any other suitable clause, or any combination of suitable clauses, wherein contacting the produce with the ferrate solution is for a time period of between about 30 minutes to about 60 minutes.
137. The method of any of clauses 1 to 4, any other suitable clause, or any combination of suitable clauses, wherein contacting the produce with the ferrate solution is for a time period of between about 60 minutes to about 90 minutes.
138. The method of any of clauses 1 to 4, any other suitable clause, or any combination of suitable clauses, wherein contacting the produce with the ferrate solution is for a time period of between about 90 minutes to about 120 minutes.
139. The method of any of clauses 1 to 4, any other suitable clause, or any combination of suitable clauses, wherein contacting the produce with the ferrate solution is for a time period of between about 1 minutes to about 5 minutes.
140. The method of any of clauses 1 to 4, any other suitable clause, or any combination of suitable clauses, wherein contacting the produce with the ferrate solution is for a time period of between about 1 minutes to about 10 minutes.
141. The method of any of clauses 1 to 4, any other suitable clause, or any combination of suitable clauses, wherein contacting the produce with the ferrate solution is for a time period of between about 10 minutes to about 20 minutes.
142. The method of any of clauses 1 to 4, any other suitable clause, or any combination of suitable clauses, wherein contacting the produce with the ferrate solution is for a time period of between about 20 minutes to about 30 minutes.
143. The method of any of clauses 1 to 4, any other suitable clause, or any combination of suitable clauses, wherein contacting the produce with the ferrate solution is for a time period of between about 30 minutes to about 40 minutes.
144. The method of any of clauses 1 to 4, any other suitable clause, or any combination of suitable clauses, wherein contacting the produce with the ferrate solution is for a time period of between about 40 minutes to about 50 minutes.
145. The method of any of clauses 1 to 4, any other suitable clause, or any combination of suitable clauses, wherein contacting the produce with the ferrate solution is for a time period of between about 50 minutes to about 60 minutes.
146. The method of any of clauses 1 to 4, any other suitable clause, or any combination of suitable clauses, wherein contacting the produce with the ferrate solution is for a time period of between about 60 minutes to about 70 minutes.
147. The method of any of clauses 1 to 4, any other suitable clause, or any combination of suitable clauses, wherein contacting the produce with the ferrate solution is for a time period of between about 70 minutes to about 80 minutes.
148. The method of any of clauses 1 to 4, any other suitable clause, or any combination of suitable clauses, wherein contacting the produce with the ferrate solution is for a time period of between about 80 minutes to about 90 minutes.
149. The method of any of clauses 1 to 4, any other suitable clause, or any combination of suitable clauses, wherein contacting the produce with the ferrate solution is for a time period of between about 90 minutes to about 100 minutes.
150. The method of any of clauses 1 to 4, any other suitable clause, or any combination of suitable clauses, wherein contacting the produce with the ferrate solution is for a time period of between about 100 minutes to about 110 minutes.
151. The method of any of clauses 1 to 4, any other suitable clause, or any combination of suitable clauses, wherein contacting the produce with the ferrate solution is for a time period of between about 110 minutes to about 120 minutes.
152. The method of any of clauses 1 to 4, any other suitable clause, or any combination of suitable clauses, wherein the method of treating further comprises contacting the produce with a disinfectant.
153. The method of clause 152, any other suitable clause, or any combination of suitable clauses, wherein the disinfectant comprises bleach.
154. The method of clause 152, any other suitable clause, or any combination of suitable clauses, wherein the disinfectant comprises a quaternary ammonium compound.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

### EXAMPLE 1

### Evaluation of Ferrate Solutions for E. Coli Contamination of Produce

In the instant example, the ferrate solutions of the present disclosure were analyzed for their ability to disinfect and/or decontaminate spinach contaminated with E. coli.

This exemplary procedure demonstrates the efficacy of the ferrate solutions of the present disclosure against food-borne diseases that may be caused by produce.

Spinach was pre-contaminated with E. coli by dipping cleaned spinach leaves in water contaminated with E. coli.The contaminated water contained 1.5 million counts of E. coli per mL. The contaminated spinach was placed in one of three different groups: i) treated with activated ferrate solution, ii) treated with plain tap water, or iii) not treated.

Within one minute of treatment as described above, the spinach groups were plated after vortex of the leaves in 1.0 ml of water to dislodged any remaining E. coli from the leaves. The plates were then incubated for growth of bacteria.

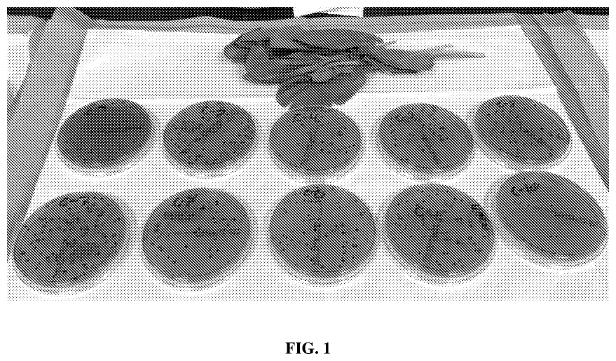

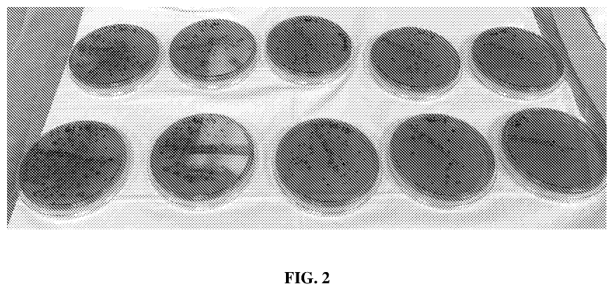

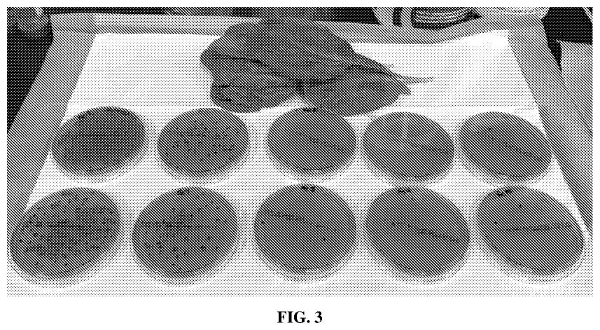

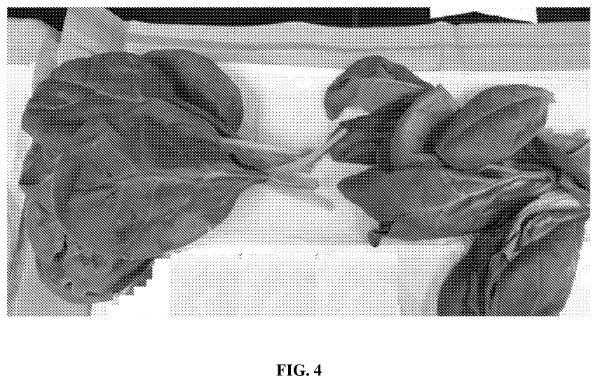

Plates were observed for 24 hours for to evaluate growth of bacteria. A large amount of bacterial growth was observed on the untreated spinach (see FIG. 1). Some bacterial growth was observed on the spinach treated with plain tap water (see FIG. 2). Significant elimination of E. coli was observed on the spinach treated with the activated ferrate solution (see FIG. 3). Further, a comparison of the spinach treated with activated ferrate solution and the spinach treated with plain tap water is shown in FIG. 4.

Similarly, the spinach treated with activated ferrate solution demonstrated more freshness, a more vibrant color, and lack of shriveling compared to the spinach treated with plain tap water.

Separately, water contaminated with E. coli was mixed in equal part with the activated ferrate solution and used to treat spinach leaves. This mixed solution was observed to achieve a 6-log reduction in E. coli on the spinach leaves.

In summary, the observed results are indicative of the capability of the ferrate solutions of the present disclosure to disinfect and/or decontaminate produce and thereby prolong the shelf life of the produce.

1. A method of treating produce, said method comprising the step of contacting the produce with a ferrate solution.

2. The method of claim 1, wherein the method prolongs shelf life of the produce.

3. The method of claim 1, wherein the method disinfects the produce.

4. The method of claim 1, wherein the method decontaminates the produce.

5. The method of claim 1, wherein the produce is a food.

6. The method of claim 1, wherein the produce is a meat.

7. The method of claim 1, wherein the produce is seafood.

8. (canceled)

9. (canceled)

10. The method of claim 1, wherein the produce is a fruit.

11. The method of claim 10, wherein the fruit is a berry.

12. The method of claim 1, wherein the produce is a vegetable.

13. The method of claim 12, wherein the vegetable is spinach.

14. The method of claim 12, wherein the vegetable is lettuce.

15. The method of claim 12, wherein the vegetable is a sprout.

16. The method of claim 1, wherein the produce is raw produce.

17. The method of claim 1, wherein the method of treating is performed in a field.

18. The method of claim 1, wherein the method of treating is performed in a processing facility.

19. The method of claim 1, wherein the method of treating is performed in a fishery.

20. The method of claim 1, wherein the method of treating is performed in a store.

21. The method of claim 20, wherein the store is a grocery store.

22. The method of claim 20, wherein the store is a supermarket.

23.-46. (canceled)
